(19) United States
(12) Patent Application Publication
(10) Pub. No.: US 2025/0353435 A1
(43) Pub. Date: Nov. 20, 2025

(54) INFORMATION PROCESSING DEVICE

(71) Applicant: KYOCERA Corporation, Kyoto-shi, Kyoto (JP)

(72) Inventors: Masataka SUGIE, Yokohama-shi, Kanagawa (JP); Ryotaro OKADA, Yokohama-shi, Kanagawa (JP); Hideki TAJIMA, Yokosuka-shi, Kanagawa (JP); Yousuke NAKANISHI, Setagaya-ku, Tokyo (JP); Toshiyuki YASUDA, Yokohama-shi, Kanagawa (JP); Takeshi SHINTANI, Otsu-shi, Shiga (JP); Atsushi YAMAZAKI, Chigasaki-shi, Kanagawa (JP); Shingo FUJIWARA, Yokohama-shi, Kanagawa (JP); Tadashi YOKOTA, Yamato-shi, Kanagawa (JP)

(73) Assignee: KYOCERA Corporation, Kyoto-shi, Kyoto (JP)

(21) Appl. No.: 18/862,874

(22) PCT Filed: May 1, 2023
(86) PCT No.: PCT/JP2023/017072

§ 371 Date: Nov. 4, 2024

(30) Foreign Application Priority Data
May 6, 2022 (JP) 2022-076739

(51) Int. Cl. B60R 1/25; B60Q 5/00; B60Q 9/00; G06V 20/20; G06V 20/58

(52) U.S. Cl. CPC B60R 1/25; B60Q 5/006; B60Q 9/008; G06V 20/20; G06V 20/58; B60R 2300/303; B60R 2300/8093

(57) ABSTRACT

An information processing device includes an acquiring unit and a controller. The acquiring unit is configured to acquire an image of the surrounding of a vehicle from at least one camera. The controller is configured to generate an assistance image using the image of the surroundings. In the assistance image a first partial image is superimposed on a second partial image. The first partial image includes a mark. The mark indicates the position of a maximum movement part of an outer surface of the vehicle. The maximum movement part is a part that moves with a maximum radius of curvature behind a minimum movement part when turning right or left. The minimum movement part is a part that moves with a minimum radius of curvature when turning right or left. The second partial image includes an image of at least part of the vehicle.

### CROSS-REFERENCE TO RELATED APPLICATIONS

This application claims priority from Japanese Patent Application No. 2022-76739 filed in Japan on May 6, 2022, and the entire disclosure of this application is hereby incorporated by reference.

### TECHNICAL FIELD

The present invention relates to an information processing device.

### BACKGROUND OF INVENTION

In order to alert the driver of a vehicle of the possibility of collision when turning right or left, a method in which the anticipated trajectory line of the rear wheel is displayed in a superimposed manner on a composite reference image of the driver's vehicle has been proposed (see Patent Literature 1).

### CITATION LIST

### Patent Literature

Patent Literature 1: Japanese Unexamined Patent Application Publication No. 2012-168752

### SUMMARY

In a First Aspect, an information processing device is installed in a vehicle.

The information processing device includes an acquiring unit and a controller.

The acquiring unit is configured to acquire an image of surroundings of the vehicle from at least one camera.

The controller is configured to generate, using the image of the surroundings, an assistance image in which a first partial image is superimposed on a second partial image. The second partial image includes an image of at least part of the vehicle. The first partial image includes a mark indicating a position of a maximum movement part, of an outer surface of the vehicle, that moves with a maximum radius of curvature behind a minimum movement part, of the outer surface of the vehicle, that moves with a minimum radius of curvature when turning right or left.

### BRIEF DESCRIPTION OF THE DRAWINGS

FIG. 1 is a side view of a vehicle including an information processing device according to an embodiment.

FIG. 2 is a top view of the vehicle in FIG. 1.

FIG. 3 is a block diagram illustrating a schematic configuration of the information processing device in FIG. 1.

FIG. 4 is a diagram for explaining a maximum movement part and a minimum movement part of a vehicle in which the movement trajectory of the vehicle when turning left is viewed from vertically above.

FIG. 5 is a diagram illustrating an example of a left original image and a right original image as assistance images.

FIG. 6 is a diagram illustrating an example of a processed side view image as an assistance image.

FIG. 7 is a diagram illustrating an example of a processed top view image as an assistance image.

FIG. 8 is a diagram illustrating another example of a left original image and a right original image as assistance images.

FIG. 9 is a diagram illustrating another example of a processed side view image as an assistance image.

FIG. 10 is a diagram illustrating another example of a processed top view image as an assistance image.

FIG. 11 is a diagram illustrating another example of a left original image and a right original image as assistance images.

FIG. 12 is a diagram illustrating yet another example of a processed side view image as an assistance image.

FIG. 13 is a diagram illustrating yet another example of a processed top view image as an assistance image.

FIG. 14 is a flowchart for describing assistance image generating processing executed by a controller in FIG. 3.

### DESCRIPTION OF EMBODIMENTS

Hereafter, an embodiment of an information processing device to which the present disclosure has been applied will be described while referred to the drawings.

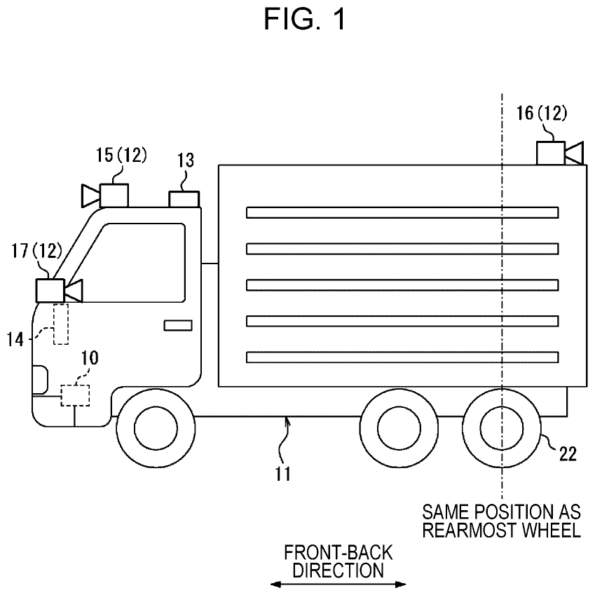

As illustrated in FIG. 1, in an embodiment, an information processing device 10 may be installed in a vehicle 11. The vehicle 11 may further include at least one camera 12, a communication device 13, and a display 14. The vehicle 11 may be any type of vehicle. The vehicle 11 is, for example, a truck including a cargo bed having side surfaces parallel to the front-back direction, a tank lorry, or a bus having a relatively long overall length.

The camera 12 is provided to be able to capture the scene around the vehicle 11 as well as a portion of the vehicle 11. The camera 12 may supply an image generated through image capturing to the information processing device 10 as information.

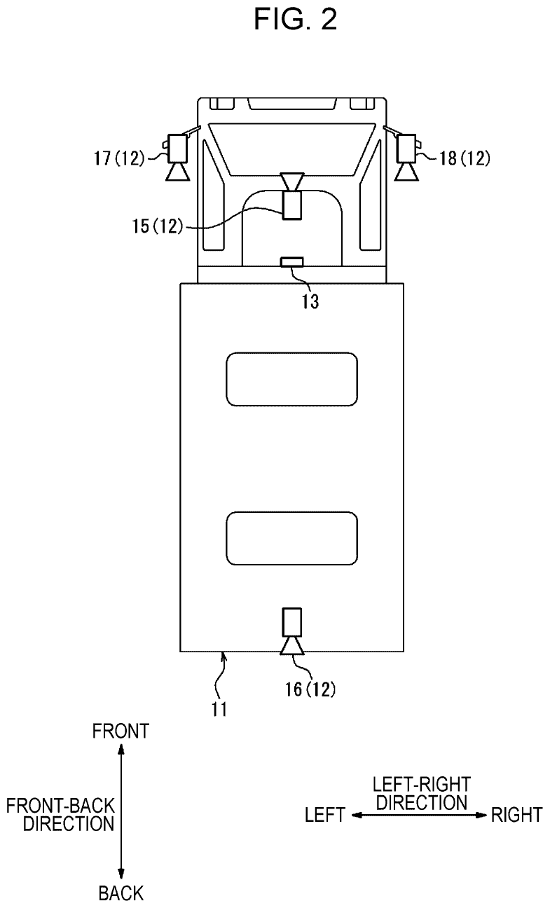

As illustrated in FIG. 2, in this embodiment, the vehicle 11 includes a first camera 15, a second camera 16, a third camera 17, and a fourth camera 18 as the at least one camera 12. The first camera 15 is, for example, provided to be capable of capturing the scene in front of the vehicle 11. The second camera 16 is, for example, provided to be capable of capturing the scene behind the vehicle 11. The third camera 17 is, for example, provided to be capable of capturing the scene at the left side and the left rear side of the vehicle 11. The fourth camera 18 is, for example, provided to be capable of capturing the scene at the right side and the right rear side of the vehicle 11. The optical axes of the first to fourth cameras 15 to 18 may be perpendicular to a width direction of the vehicle 11.

The communication device 13 may be capable of wireless communication with an external camera located in the vicinity of the vehicle 11. The external camera may be, for example, installed in a roadside machine, another vehicle, a building, or a flying object such as a drone. The communication device 13 may acquire images captured by the external camera from the external camera as information together with the position of the external camera.

The display 14 may be disposed at a position visible from the driver's seat. The display 14 may display an assistance image generated by the information processing device 10, which is described later. The display 14 may be a known type of display such as a liquid crystal display or a head mounted display.

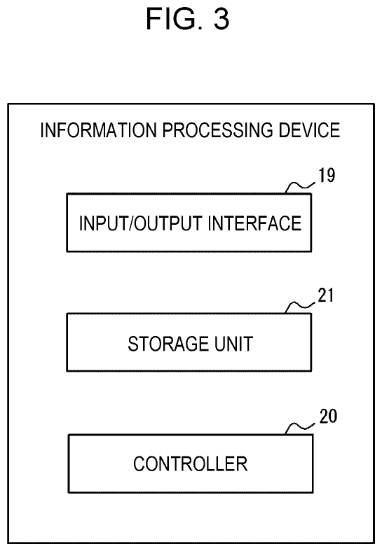

The information processing device 10 generates an assistance image using images of the surroundings of the vehicle 11 acquired from the camera 12 and external cameras. Hereafter, the configuration of the information processing device 10 will be described. As illustrated in FIG. 3, the information processing device 10 includes an input/output interface (acquiring unit) 19 and a controller 20. The information processing device 10 may further include a storage unit 21.

The input/output interface 19 acquires images of the surroundings of the vehicle 11 from at least one of the camera 12 or an external camera. The input/output interface 19 may acquire maneuvering information of the vehicle 11 from the vehicle 11. The maneuvering information may include, for example, the velocity, acceleration, and steering angle of the vehicle 11. The input/output interface 19 may provide the display 14 with an assistance image generated by the controller 20, as described below.

The storage unit 21 includes any storage device such as a RAM (random access memory) or a ROM (read only memory). The storage unit 21 may store various programs that allow the controller 20 to function and various information used by the controller 20.

The storage unit 21 may, for example, store a specific position in a three-dimensional coordinate system with a point defined with respect to the vehicle 11 as the origin. The specific position is the position of a maximum movement part.

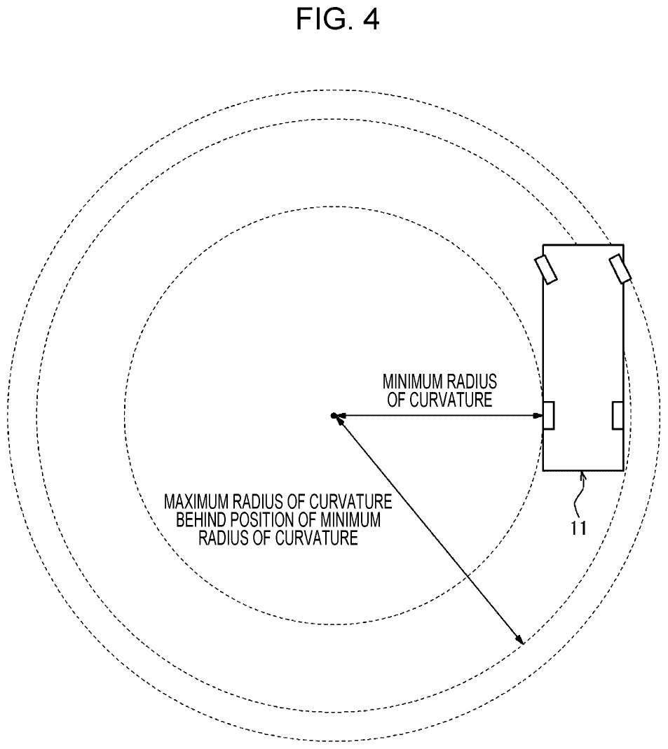

As illustrated in FIG. 4, the maximum movement part may be the part of the outer surface of the vehicle 11 that moves with a maximum radius of curvature behind a minimum movement part, which is described below, in the front-back direction of the vehicle 11 when turning right or left. The maximum movement part may be the part of the outer surface of the vehicle 11 that moves with the maximum radius of curvature behind the driver's seat of the vehicle 11 in the front-back direction of the vehicle 11 when turning right or left. For example, the maximum movement part is the part having the greatest width, within the height direction, at the rear end, in the front-back direction, of a side surface of the cargo bed in a configuration where the vehicle 11 is a truck. Furthermore, for example, the maximum movement part is a part at the same position as the rear end of the cargo bed and at any position in the vertical direction in a configuration in which the side surfaces of the cargo bed are flat surfaces perpendicular to the width direction.

The minimum movement part is the part of the outer surface of the vehicle 11 that moves with the minimum radius of curvature when turning right or left. Specifically, as illustrated in FIG. 1, the minimum movement part is the part having the greatest width, within the height direction, at the same position as a rearmost wheel 22 in the front-back direction of the vehicle 11. For example, the minimum movement part is the part at the same position as the rearmost wheel 22 and at any position in the vertical direction in a configuration in which the vehicle 11 is a truck and the side surfaces of the cargo bed are flat surfaces perpendicular to the width direction.

The storage unit 21 also stores a transformation formula or transformation table for coordinate transformation with which images of the surroundings are transformed into a composite image in a configuration in which the assistance image described below includes a composite image based on the images of the surroundings acquired from the input/output interface 19.

The controller 20 includes one or more processors and memories. Such processors may include general-purpose processors into which specific programs are loaded to perform specific functions, and dedicated processors dedicated to specific processing. Dedicated processors may include an ASIC (application specific integrated circuit). Processors may include PLDs (programmable logic devices). PLDs may include FPGAs (field-programmable gate arrays). The controller 20 may be either a SoC (system-on-a-chip) or an SiP (system-in-a-package), in which one or more processors cooperate with each other.

The controller 20 generates an assistance image using an image of the surroundings acquired by the input/output interface 19. The assistance image is an image in which a first partial image is superimposed on a second partial image. The assistance image may further include an image in which a third partial image is superimposed on the second partial image. The first partial image is an image that includes a mark indicating the position of the maximum movement part or a position shifted in the width direction of the vehicle 11 from that position at a prescribed spacing. The prescribed spacing is the length of an allowance considered as a margin to avoid contact with obstacles at a side surface of the vehicle 11 and is, for example, but not limited to, 10 cm. The prescribed spacing may be freely determined by being specified by the user. Alternatively, the controller 20 may determine the prescribed spacing in accordance with the traveling velocity of the vehicle 11. The controller 20 may acquire the traveling velocity of the vehicle 11 and determine the prescribed spacing so that the spacing is larger for a faster traveling velocity compared to a slower traveling velocity. Alternatively, in a configuration in which the vehicle 11 is a truck with a cargo bed, the controller 20 may determine the prescribed spacing in accordance with the weight of the cargo on the cargo bed. The controller 20 may acquire the weight of the cargo from a weight sensor attached to the cargo bed and determine the prescribed spacing so that the spacing is greater for a heavier weight compared to a lighter weight. Alternatively, the controller 20 may determine the prescribed spacing in accordance with the overall length of the vehicle 11, in other words, the length in the front-back direction. The controller 20 may calculate the overall length of the vehicle 11 from images captured by the third camera 17 or the fourth camera 18 and determine the prescribed spacing so that the spacing is greater for a longer overall length of the vehicle 11 compared to a shorter overall length. The second partial image is an image of the vehicle 11, in which the information processing device 10 is installed, included in an image of the surroundings. The second partial image may include an image of at least part of the vehicle 11. The third partial image is an image that includes a mark indicating the position of the minimum movement part or a position shifted in the width direction of the vehicle 11 from that position at a prescribed spacing.

The assistance image may be an image in which the vehicle 11 is viewed from a particular viewpoint with respect to the vehicle 11. The assistance image may be a single image or may include multiple images. The assistance image may include, for example, a side view display image and a top view display image. The side view display image is an image that includes a side surface of the vehicle 11 as the second partial image. The top view display image is an image that includes the top surface of the vehicle 11 as a partial image such as an image in which the vehicle 11 is viewed from above. For example, an image in which the viewpoint is above the rear side or front side of the vehicle 11 may include a side view display image and a top view display image. The types of images, such as side view display images, to be included in the assistance image may be determined in advance or selected later.

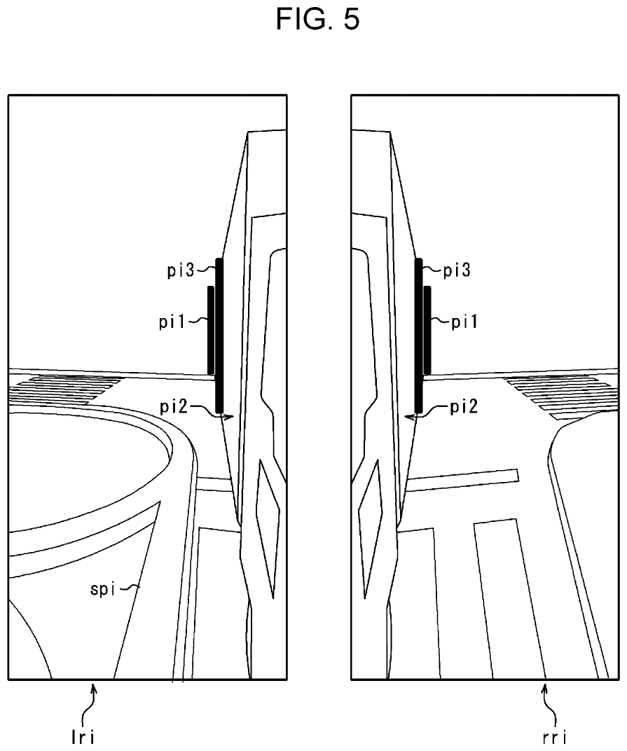

The assistance image may be generated by superimposing visual information on the images of the surroundings acquired by the input/output interface 19. For example, as illustrated in FIG. 5, side view display images included in the assistance image may include a left original image Iri generated through image capturing performed by the third camera 17 and a right original image rri generated through image capturing performed by the fourth camera 18. As described above, a first partial image pi1, which is an image of a mark indicating the maximum movement part, and a third partial image pi3, which is an image of a mark indicating the minimum movement part, are superimposed on a second partial image pi2, which is an image of the vehicle 11, in each of the left original image lri and the right original image rri. In a configuration in which the maximum movement part and the minimum movement part are shaped like continuous lines, the marks indicating the parts may be lines, or may be any one point along the line, or may be multiple discrete points.

Alternatively, the assistance image may be generated by superimposing visual information on a processed image based on an image of the surroundings. A processed image based on an image of the surroundings may be generated by performing a coordinate transformation on a single image of the surroundings, or by combining multiple images of the surroundings and performing a coordinate transformation if necessary.

Furthermore, the assistance image generated by the controller 20 may employ a position away from the vehicle 11 as a viewpoint.

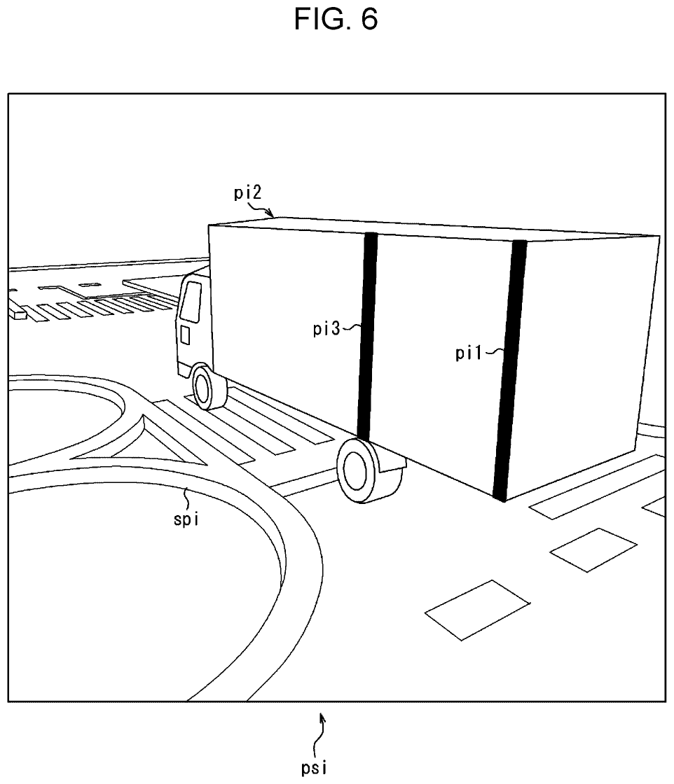

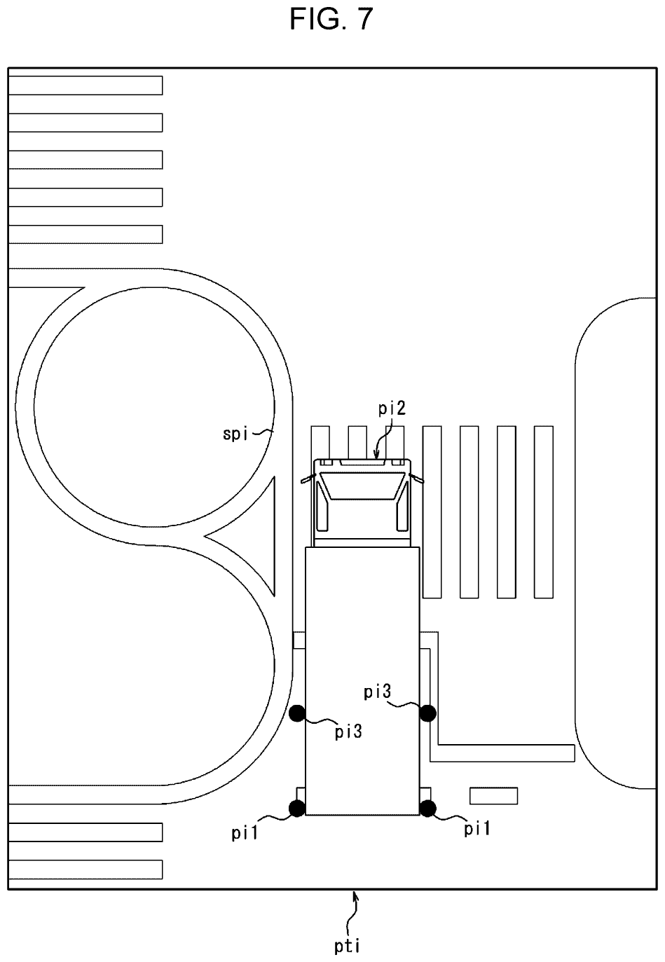

For example, the controller 20 may generate a side view display image by processing at least one of an image of the surroundings generated by the third camera 17 or the fourth camera 18 or an image captured by an external camera, or by combining both types of image. As illustrated in FIG. 6, the side view display image generated by the controller 20 may be a processed side view image psi, which is a transformed image with a viewpoint at an angle above the vehicle 11. In the processed side view image psi, the first partial image pi1, which is an image of a mark indicating the maximum movement part, and the third partial image pi3, which is an image of a mark indicating the minimum movement part, are superimposed on the second partial image pi2, which is an image of the vehicle 11. In a configuration in which the maximum movement part and the minimum movement part are shaped like continuous lines, the marks indicating the parts may be lines, or may be any one point along the line, or may be multiple discrete points. As illustrated in FIG. 7, the top view display image generated by the controller 20 may be a processed top view image pti, which is a transformed image with a viewpoint vertically above the vehicle 11. In the processed top view image pti as well, the first partial image pi1 and the third partial image pi3 are superimposed on the second partial image pi2.

The assistance image may be an image of a viewpoint that includes a partial image spi of a curb located in the vicinity of the vehicle 11. The controller 20 may determine the position of the viewpoint so that the assistance image includes the partial image spi of the curb. For example, the viewpoint and angle of view are set so that the partial image spi of the curb is included in the left original image lri, the right original image rri, the processed side view image psi, and the processed top view image pti described above.

In the assistance image, the first partial image pi1 may include the trajectory of future movement of the above marks as the vehicle 11 travels.

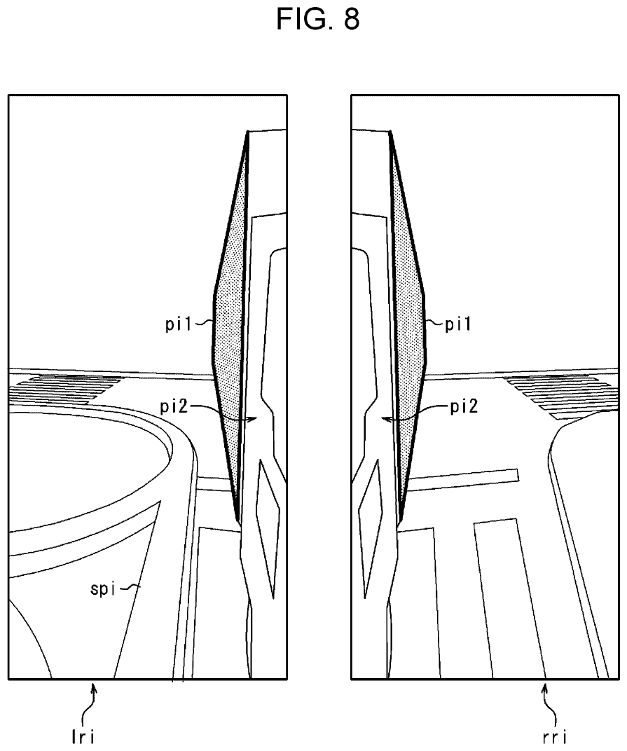

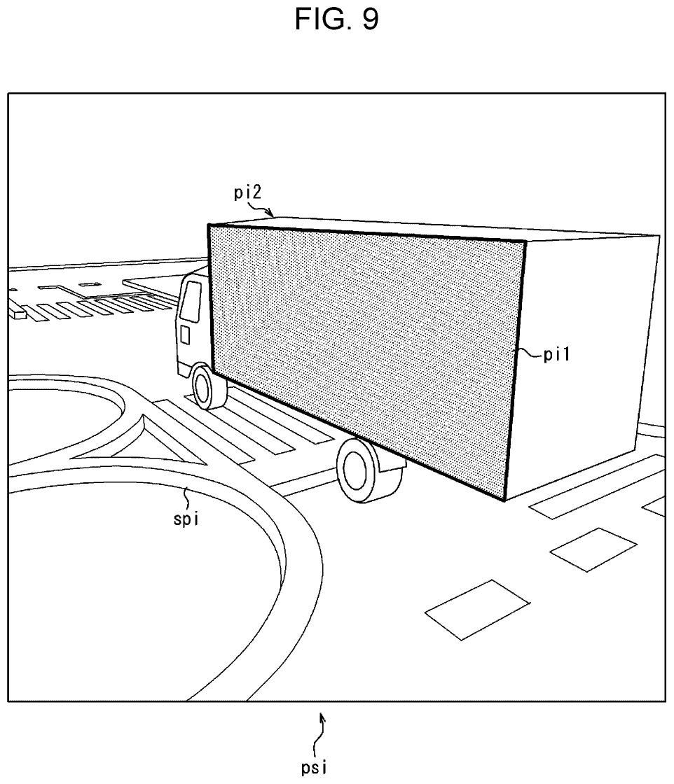

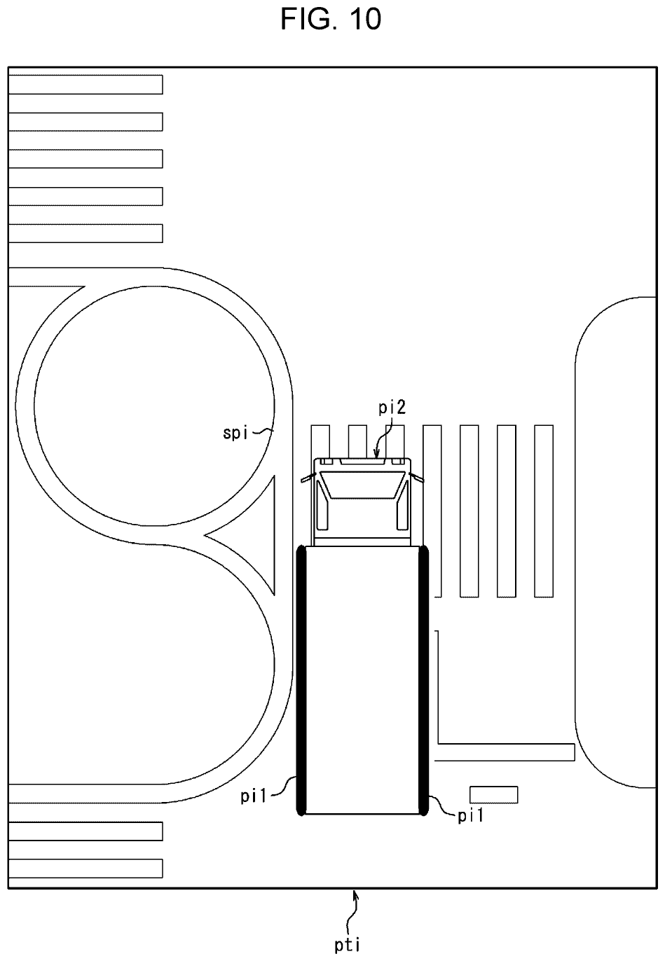

For example, when the vehicle 11 is traveling straight ahead, in a configuration where the assistance images are the left original image lri and the right original image rri, the first partial image pi1 representing the trajectory of a mark is shaped like a flat surface, as illustrated in FIG. 8. When the vehicle 11 is traveling straight ahead, in a configuration in which the assistance image is the processed side view image psi, the first partial image pi1 representing the trajectory of a mark is shaped like a flat surface, as illustrated in FIG. 9. When the vehicle 11 is traveling straight ahead, in a configuration in which the assistance image is the processed top view image pti, the first partial image pi1 indicating the trajectory of a mark is shaped like a straight line, as illustrated in FIG. 10.

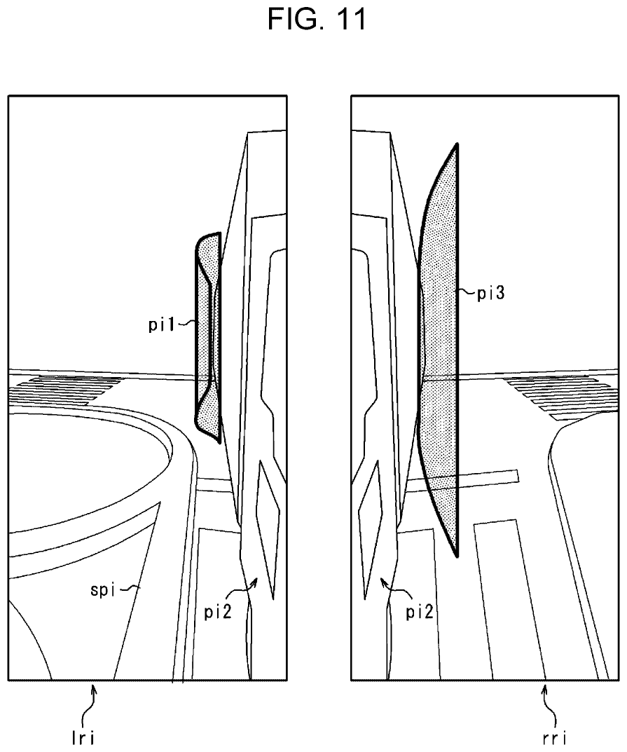

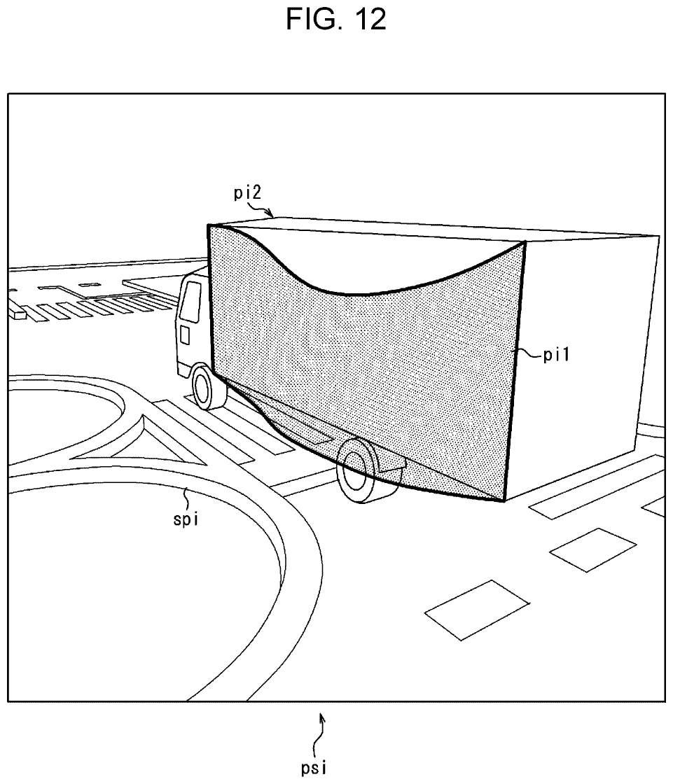

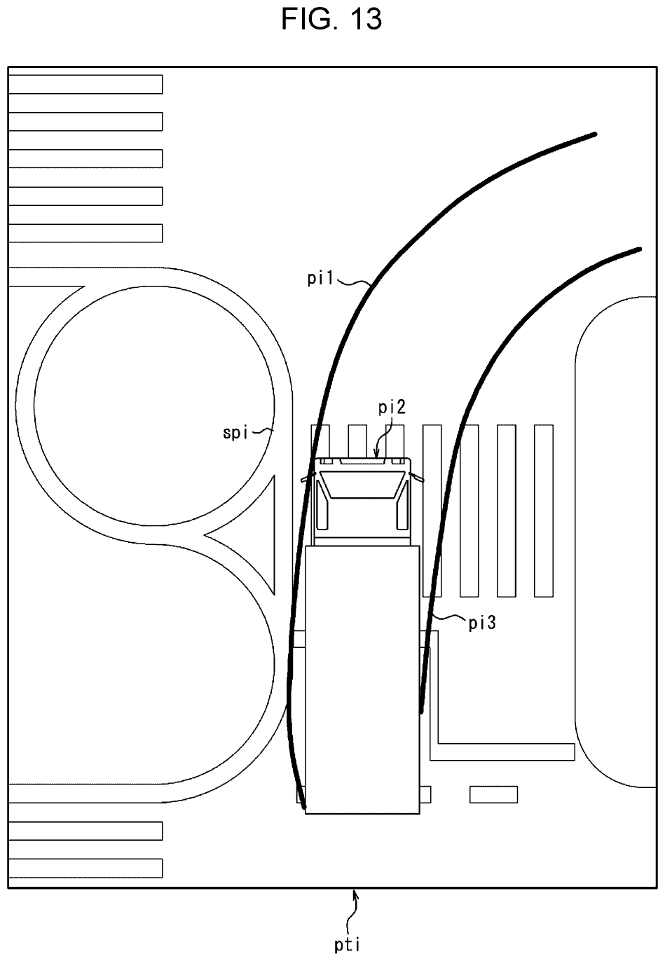

For example, when the vehicle 11 turns right, in a configuration in which the assistance images are the left original image lri and the right original image rri, as illustrated in FIG. 11, the first partial image pi1 and the third partial image pi3 indicating the trajectories of marks are shaped like curved surfaces. When the vehicle 11 turns right, in a configuration in which the assistance image is the processed side view image psi, the first partial image pi1 and the third partial image pi3 indicating the trajectories of marks are shaped like curved surfaces, as illustrated in FIG. 12. When the vehicle 11 turns right, in a configuration in which the assistance image is the processed top view image pti, the first partial image pi1 and the third partial image pi3 indicating the trajectories of marks are shaped like curved surfaces, as illustrated in FIG. 13.

The controller 20 may preferentially superimpose the third partial image pi3, rather than the first partial image pi1, on the second partial image pi2 on the turning direction side of the vehicle 11 in the left-right direction. For example, the controller 20 may superimpose only the third partial image pi3 on the turning direction side of the vehicle 11 in the left-right direction. Alternatively, the controller 20 may preferentially superimpose the first partial image pi1, rather than the third partial image pi3, on the second partial image pi2 on the opposite side from the turning direction side of the vehicle 11 in the left-right direction. For example, the controller 20 may superimpose only the first partial image pi1 on the opposite side from the turning direction side of the vehicle 11 in the left-right direction.

The controller 20 may create the first partial image pi1 and the third partial image pi3 by calculating the trajectories of the marks based on the steering angle and velocity of the vehicle 11 when the vehicle 11 turns right or left. If there is a possibility of the vehicle body tilting when the vehicle 11 turns right or left, the controller 20 may calculate the trajectories of inclined marks and create the first partial image pi1 and the third partial image pi3. The trajectory of a mark may be the entirety of the anticipated trajectory of the vehicle 11 from the start of the right or left turn to the end of the turn, or may be part of the trajectory. Depending on the progress of the vehicle 11 turning right or left, the trajectory that has already passed may be erased or may continue to be displayed. If the steering angle or velocity of the vehicle 11 changes, the controller 20 may re-calculate the trajectories of the marks and create a new first partial image pi1 and a new third partial image pi3.

When an obstacle is located to the side of the direction of travel of the vehicle 11, the controller 20 may determine whether or not the obstacle intersects the trajectory of a mark. The assistance image may be created as an image from a viewpoint such that a partial image of the obstacle is included in the image. Obstacles include, for example, pedestrians, other vehicles, billboards, curve mirrors, signs, etc. in the vicinity of the vehicle 11. The intersection of the obstacle and the trajectory of the mark results in an overlap between the position corresponding to the mark and the position of the obstacle in real space. In other words, the intersection of the obstacle and the trajectory of the mark may result in the vehicle 11 colliding with the obstacle during the process of turning right or left in a configuration in which the position of the mark is part of the body of the vehicle 11. The controller 20 may cause a warning display or the like to be included in the assistance image when the obstacle intersects the trajectory of the mark. Warning displays may include changes in the display format of the partial image of the obstacle and the trajectory of the mark. Changes in display format may include changes in the colors displayed, blinking, and so on. In the trajectory of a mark, a part of the trajectory that intersects an obstacle and other parts of the trajectory may be displayed in different formats. The controller 20 may emit a warning sound from a speaker instead of or simultaneously with the warning display, etc. The controller 20 may highlight all or part of the outer edge of a partial image of an obstacle in the assistance image, or may display an image indicating the position of the obstacle. The controller 20 may determine whether or not an obstacle exists to the side of the direction of travel of the vehicle 11 from the images of the surroundings acquired by the input/output interface 19 when turning right or left, and display the trajectory of a mark on the display 14 only when such an obstacle exists.

The controller 20 may supply the assistance image generated as described above and display the assistance image on the display 14.

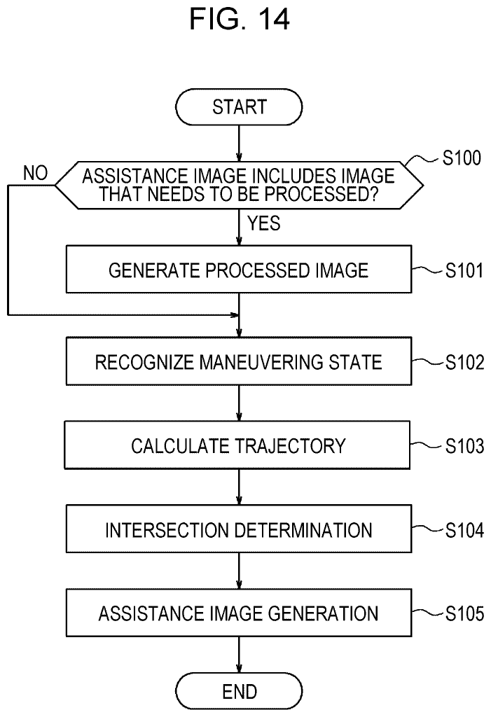

Next, the flowchart in FIG. 14 will be used to describe assistance image processing performed by the controller 20 of the information processing device 10 in this embodiment. The assistance image generating processing is, for example, initiated periodically in accordance with the period at which images of the surroundings are acquired from the camera 12 and external cameras.

In Step S100, the controller 20 determines whether or not an assistance image includes an image of a type that needs to be processed based on an image of the surroundings. When such an image is included, the process advances to Step S101. When such an image is not included, the process advances to Step S102.

In Step S101, the controller 20 performs processing on the image of the surroundings in order to generate an image for superimposing of the first partial image pi1. After that, the process advances to Step S102.

In Step S102, the controller 20 recognizes the latest maneuvering state based on the maneuvering information most recently acquired from the vehicle 11. After that, the process advances to Step S103.

In Step S103, the controller 20 calculates the trajectory of movement of a mark in the image coordinate system for each type of image included in the assistance image based on a specific position stored in the storage unit 21 and the maneuvering state recognized in Step S102. After that, the process advances to Step S104.

In Step S104, when there is an obstacle located to the side of the direction of travel of the vehicle 11, the controller 20 determines whether or not the obstacle intersects the trajectory of movement of the mark calculated in Step S103. After that, the process advances to Step S105.

In Step S105, the controller 20 generates an assistance image by superimposing the first partial image pi1 and the third partial image pi3, which are the trajectories calculated in Step S103, on the image for superimposing the first partial image pi1. Furthermore, the controller 20 adds an image effect such as blinking to the assistance image to clearly indicate the obstacle determined to intersect the trajectory in Step S104. Furthermore, the controller 20 supplies the generated assistance image to the display 14 and displays the assistance image on the display 14. After generating the assistance image, the assistance image generating processing is terminated.

The information processing device 10 of this embodiment configured as described above generates an assistance image using an image of the surroundings. In the assistance image, a first partial image pi1 is superimposed on a second partial image pi2 of the vehicle 11. The first partial image pi1 includes a mark indicating the position of a maximum movement part, of the outer surface of the vehicle 11, that moves with a maximum radius of curvature behind a minimum movement part, of the outer surface of the vehicle 11, that moves with a minimum radius of curvature when turning right or left. With this configuration, the information processing device 10 can allow the driver to see the maximum movement part that moves at the maximum radius of curvature behind the minimum movement part when making a turn, and therefore reduce the likelihood of a collision.

Alternatively, the information processing device 10 of this embodiment generates an assistance image using an image of the surroundings. In the assistance image, a first partial image pi1 is superimposed on a second partial image pi2 of the vehicle 11. The first partial image pi1 includes a mark indicating a position shifted in the width direction of the vehicle by a prescribed spacing from the position of a maximum movement part, of the outer surface of the vehicle 11, that moves with a maximum radius of curvature behind a minimum movement part, of the outer surface of the vehicle 11, that moves with a minimum radius of curvature when turning right or left. With this configuration, the information processing device 10 can allow the driver to see the maximum movement part that moves at the maximum radius of curvature behind the minimum movement part when making a turn, and therefore reduce the likelihood of a collision.

Alternatively, the information processing device 10 of this embodiment generates an assistance image using an image of the surroundings. In the assistance image, a first partial image pi1 is superimposed on a second partial image pi2 of the vehicle 11. The first partial image pi1 includes a mark indicating a position that is shifted in the width direction of the vehicle by a prescribed spacing from the position of a maximum movement part of the outer surface of the vehicle 11 that is behind the driver's seat and moves with a maximum radius of curvature when turning right or left or indicates a position shifted in the width direction of the vehicle from that position by a prescribed spacing. With this configuration, the information processing device 10 can allow the driver to see the maximum movement part that moves with the maximum radius of curvature behind the driver's seat when making a turn, and therefore reduce the likelihood of a collision.

Alternatively, in the information processing device 10 of this embodiment, the first partial image pi1 includes the trajectory of future movement of a mark as the vehicle 11 travels. With this configuration, the information processing device 10 can more easily make visible the path of travel having a wider region behind the driver's seat than the trajectory of the driver's seat, which is difficult to grasp when making a turn. Therefore, the information processing device 10 can further reduce the likelihood of a collision.

In addition, when an obstacle is located to the side of the direction of travel of the vehicle 11, the information processing device 10 of this embodiment determines whether or not a mark intersects the obstacle under the assumption that the vehicle 11 is turning right or left. With this configuration, the information processing device 10 can allow the driver to clearly recognize the possibility of a collision between the vehicle 11 and an obstacle.

In addition, in the information processing device 10 of this embodiment, the assistance image includes a side view display image that includes a side surface of the vehicle 11 as the second partial image. If the vehicle 11 has a relatively long overall length, part of a side surface of the vehicle 11 may pass through a position that sticks out more than the region through which the front wheel passes when turning right or left, and therefore may collide with an object located to the side of the vehicle 11. For such incidents, the information processing device 10 having the above configuration can allow the driver to see the side surface of the vehicle 11, and therefore can further reduce the likelihood of a collision.

In addition, in the information processing device 10 of this embodiment, the assistance image includes the partial image spi of a curb located in the vicinity of the vehicle 11. With this configuration, the information processing device 10 can reduce the possibility of mounting the curb and colliding with the curb when turning right or left.

In addition, the information processing device 10 of this embodiment determines a prescribed spacing based on the traveling velocity of the vehicle 11 or the length of the vehicle 11 in the front-back direction. If the traveling velocity of the vehicle 11 is high, there is a high likelihood that the vehicle will lean over significantly when making a right or left turn. For example, the prescribed spacing may be made larger when the traveling velocity is higher compared to when the traveling velocity is lower. In addition, if the body of the vehicle 11 is long in the front-back direction, making a right or left turn is more difficult for the vehicle 11. For example, the prescribed spacing may be made larger when the length of the body is long compared to when the length is short. With this configuration, the information processing device 10 enables contact between the body of the vehicle 11 and an obstacle to be avoided.

In addition, the information processing device 10 of this embodiment determines the prescribed spacing based on the weight of cargo on the cargo bed. If the weight of the cargo on the cargo bed of the vehicle 11 is high, there is a high likelihood that the vehicle body will lean significantly when turning right or left. For example, the prescribed spacing may be made larger when the weight of the cargo is higher compared to when the weight is lower. With this configuration, the information processing device 10 enables contact between the body of the vehicle 11 and an obstacle to be avoided.

In an embodiment, (1) an information processing device includes
an acquiring unit configured to acquire an image of surroundings of a vehicle from at least one camera, and
a controller configured to generate, using the image of the surroundings, an assistance image in which a first partial image is superimposed on a second partial image, the second partial image including an image of at least part of the vehicle, the first partial image including a mark indicating a position of a maximum movement part, of an outer surface of the vehicle, that moves with a maximum radius of curvature behind a minimum movement part, of the outer surface of the vehicle, that moves with a minimum radius of curvature when turning right or left.

In another embodiment, (2) an information processing device includes
an acquiring unit configured to acquire an image of surroundings of a vehicle from at least one camera, and
a controller configured to generate, using the image of the surroundings, an assistance image in which a first partial image is superimposed on a second partial image, the second partial image including an image of at least part of the vehicle, the first partial image including a mark indicating a position shifted in a width direction of the vehicle by a prescribed spacing from a position of a maximum movement part, of an outer surface of the vehicle, that moves with a maximum radius of curvature behind a minimum movement part, of the outer surface of the vehicle, that moves with a minimum radius of curvature when turning right or left.

In another embodiment, (3) an information processing device includes
an acquiring unit configured to acquire an image of surroundings of a vehicle including a driver's seat from at least one camera, and
a controller configured to generate, using the image of the surroundings, an assistance image in which a first partial image is superimposed on a second partial image, the second partial image including an image of at least part of the vehicle, the first partial image including a mark indicating a position of a maximum movement part, of an outer surface of the vehicle, that is behind the driver's seat and moves with a maximum radius of curvature when turning right or left or indicates a position shifted in a width direction of the vehicle from that position by a prescribed spacing.
(4) In the information processing device of any one of (1) to (3) above,
the first partial image includes a trajectory of future movement of the mark as the vehicle travels.
(5) In the information processing device of any one of (1) to (4) above,
when an obstacle is located at a side of a direction of travel of the vehicle, the controller is configured to determine whether or not the mark intersects the obstacle while the vehicle turns right or left.
(6) In the information processing device of any one of (1) to (5) above,
the vehicle is a truck including a cargo bed,
the minimum movement part is a part having a greatest width at an identical position to a rearmost wheel of the vehicle, and
the maximum movement part is a part having a greatest width at a rear end, in a front-back direction, of a side surface of the cargo bed.
(7) In the information processing device of any one of (1) to (6) above,
the assistance image includes a side view display image including a side surface of the vehicle as the second partial image.
(8) In the information processing device of (7) above,
the side view display image is an image with a viewpoint at an angle above the vehicle.
(9) In the information processing device of any one of (1) to (8) above,
the assistance image includes a partial image of a curb located in a vicinity of the vehicle.
(10) In the information processing device of any one of (1) to (9) above,
the assistance image includes a top view display image in which the vehicle is viewed from above.
(11) In the information processing device of (2) above,
the controller is configured to determine the prescribed spacing based on a traveling velocity of the vehicle or a length of the vehicle in a front-back direction.
(12) In the information processing device of (2) above,
the vehicle is a truck including a cargo bed, and
the controller is configured to determine the prescribed spacing based on a weight of cargo loaded on the cargo bed.

An embodiment of the information processing device 10 has been described above. Embodiments of the present disclosure can be a method or program for implementing a device, as well as a storage medium on which a program is recorded (for example, an optical disk, an optical-magnetic disk, a CD-ROM, CD-R, CD-RW, magnetic tape, hard disk, or memory card, and so on.).

The embodiment of a program is not limited to an application program such as object code compiled by a compiler or program code executed by an interpreter, and can also take the form of a program module or the like incorporated into an operating system. Furthermore, the program may be or not be configured so that all processing is performed only in a CPU on a control board. The program may be configured to be implemented entirely or partially by another processing unit mounted on an expansion board or expansion unit added to the board as necessary.

The drawings illustrating the embodiment of the present disclosure are schematic drawings. The dimensional proportions and so on in the drawings do not necessarily match the actual dimensional proportions and so on.

Although embodiments of the present disclosure have been described based on the drawings and examples, please note that one skilled in the art can make various variations or changes based on the present disclosure. Please note that, therefore, these variations or changes are included within the scope of the present disclosure. For example, the functions and so on included in each constituent part can be rearranged in a logically consistent manner, and multiple constituent parts and so on can be combined into one part or divided into multiple parts.

In an embodiment of the present disclosure, for the mark included in the first partial image pi1, an assistance image indicating the position of the maximum movement part of the vehicle 11 is generated, but the mark does not need to take this form. For example, for the mark included in the first partial image pi1, an assistance image indicating any position, specified by the user, along outer edges of the vehicle 11 may be generated.

All of the constituent elements described in the present disclosure and/or all of the disclosed methods or all of the steps of disclosed processing can be combined in any combination, except for combinations in which their features would be mutually exclusive. Each of the features described in the present disclosure may be replaced by alternative features that serve the same, equivalent, or similar purposes, unless explicitly stated to the contrary. Therefore, unless explicitly stated to the contrary, each of the disclosed features is only one example of a comprehensive set of identical or equivalent features.

Furthermore, the embodiments according to the present disclosure are not limited to any of the specific configurations of the embodiments described above. The embodiments according to the present disclosure can be extended to all novel features, or combinations thereof, described in the present disclosure, or all novel methods, or processing steps, or combinations thereof, described in the present disclosure.

In the present disclosure, “first”, “second”, and so on are identifiers used to distinguish between such configurations. Regarding the configurations, “first”, “second”, and so on used to distinguish between the configurations in the present disclosure may be exchanged with each other. For example, identifiers “first” and “second” may be exchanged between a first camera and a second camera. Exchanging of the identifiers take places simultaneously. Even after exchanging the identifiers, the configurations are distinguishable from each other. The identifiers may be deleted. The configurations that have had their identifiers deleted are distinguishable from each other by symbols. Just the use of identifiers such as “first” and “second” in this disclosure is not to be used as a basis for interpreting the order of such configurations or the existence of identifiers with smaller numbers.

### REFERENCE SIGNS

10 information processing device
11 vehicle
12 camera
13 communication device
14 display
15 first camera
16 second camera
17 third camera
18 fourth camera
19 input/output interface (acquiring unit)
20 controller
21 storage unit
22 rearmost wheel
lri left original image
pi1 first partial image
pi2 second partial image
pi3 third partial image
psi processed side view image
pti processed top view image
rri right original image
spi partial image of curb

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. An information processing device comprising a controller configured to cause warning when a future trajectory of a position shifted in a width direction of a vehicle by a prescribed spacing from a first position of an outer surface of the vehicle when turning right or left intersects an obstacle located at a side of a direction of travel of the vehicle.

14. The information processing device according to claim 13,
wherein the first position is a position of a maximum movement part that moves with a maximum radius of curvature when turning right or left of the vehicle.

15. The information processing device according to claim 13,
wherein the controller is configured to determine the prescribed spacing based on a length of the vehicle in a front-back direction.

16. The information processing device according to claim 13,
wherein the controller is configured to determine the prescribed spacing based on a traveling velocity of the vehicle.

17. The information processing device according to claim 13,
wherein the controller is configured to determine the prescribed spacing based on a weight of cargo loaded on the vehicle.

18. The information processing device according to claim 15, further comprising an interface configured to acquire an image of surroundings including a side surface of the vehicle, wherein the controller configured to calculate the length of the vehicle in a front-back direction based on the image.

19. The information processing device according to claim 13, further comprising an interface configured to acquire an image of surroundings including a side surface of the vehicle, wherein the controller to generate, using the image of the surroundings, an assistance image in which a first partial image is superimposed on a second partial image, the first partial image indicating the future trajectory, the second partial image including an image of at least part of the vehicle.

20. The information processing device according to claim 13,
wherein the controller configured to emit a warning sound from a speaker as a warning.
